(19) United States
(12) Patent Application Publication
(10) Pub. No.: US 2026/0001327 A1
(43) Pub. Date: Jan. 1, 2026

(54) INKJET DEVICE

(71) Applicant: Panasonic Intellectual Property Management Co., Ltd., Osaka (JP)

(72) Inventors: KAZUKI FUKADA, Osaka (JP); HIDEHIRO YOSHIDA, Osaka (JP)

(21) Appl. No.: 19/234,326

(22) Filed: Jun. 11, 2025

(30) Foreign Application Priority Data
Jun. 28, 2024 (JP) 2024-105082

(51) Int. Cl. B41J 2/14

(52) U.S. Cl. CPC B41J 2/14274; B41J 2/1433; B41J 2002/14491; B41J 2202/11

(57) ABSTRACT

An inkjet device includes a pressure chamber that stores ink, a piezoelectric element that is away from the pressure chamber in a first direction, and a diaphragm that is disposed between the pressure chamber and the piezoelectric element in the first direction. The diaphragm includes a pressure receiving portion. The pressure receiving portion includes a top portion and a base portion. The top portion is in contact with the piezoelectric element. The base portion is connected to a body of the diaphragm. A width of the base portion is larger than a width of the top portion in a second direction that is at least one direction perpendicular to the first direction.

### BACKGROUND

### 1. Technical Field

The present disclosure relates to an inkjet device.

### 2. Description of the Related Art

In recent years, printed electronics for forming electronic devices by on-demand inkjet have been expanding.

It is necessary to convert various materials into inks for manufacturing the electronic device, and a piezoelectric driving type inkjet ejection head capable of stably ejecting a wide variety of inks has been actively developed.

For example, in the inkjet device described in PTL 1, a piezoelectric element (PZT: lead zirconate titanate) deformed by application of a voltage deforms a diaphragm, and presses a pressure chamber to eject ink.

### CITATION LIST

### Patent Literature

PTL 1: Unexamined Japanese Patent Publication No. 2012-232290

### SUMMARY

In the inkjet device described in PTL 1, when the diaphragm is deformed, stress concentrates on a projecting portion provided on the diaphragm, and the diaphragm may be damaged.

Non-limiting examples of the present disclosure contribute to providing an inkjet device capable of alleviating stress concentration on a diaphragm.

An inkjet device according to an example of the present disclosure includes a pressure chamber that stores ink, a piezoelectric element that is away from the pressure chamber in a first direction, and a diaphragm that is disposed between the pressure chamber and the piezoelectric element in the first direction. The diaphragm includes a pressure receiving portion. The pressure receiving portion includes a top portion and a base portion. The top portion is in contact with the piezoelectric element. The base portion is connected to a body of the diaphragm. A width of the base portion is larger than a width of the top portion in a second direction that is at least one direction perpendicular to the first direction.

An inkjet device according to an example of the present disclosure includes a pressure chamber that stores ink, a piezoelectric element that is away from the pressure chamber in a first direction, and a diaphragm that is disposed between the pressure chamber and the piezoelectric element in the first direction. The piezoelectric element has a central region in a second direction that is at least one direction perpendicular to the first direction, and an end portion region adjacent to the central region in the second direction. The central region receives a voltage applied to the piezoelectric element. The end portion region does not receive a voltage applied to the piezoelectric element.

An inkjet device according to an example of the present disclosure includes a pressure chamber that stores ink, a piezoelectric element that is away from the pressure chamber in a first direction, and a diaphragm that is disposed between the pressure chamber and the piezoelectric element in the first direction. The diaphragm includes a pressure receiving portion having a top portion which is in contact with the piezoelectric element. A width of the top portion is smaller than a width of the piezoelectric element in a second direction that is at least one direction perpendicular to the first direction.

According to the example of the present disclosure, it is possible to provide the inkjet device capable of alleviating the stress concentration applied to the diaphragm.

Further advantages and effects in an example of the present disclosure will be clarified from the specification and the drawings. Although such advantages and/or effects are provided by several exemplary embodiments and features described in the specification and drawings, all of them are not necessarily provided to obtain one or more identical features.

### BRIEF DESCRIPTION OF THE DRAWINGS

FIG. 1 is a plan view of an inkjet device according to a first exemplary embodiment;

FIG. 2 is an exploded perspective view illustrating an appearance of an inkjet head according to the first exemplary embodiment;

FIG. 3 is a diagram illustrating an example of a configuration of an ejection head according to the first exemplary embodiment;

FIG. 4 is a diagram illustrating an example of an XZ section of the ejection head according to the first exemplary embodiment;

FIG. 5 is a diagram illustrating an example of a YZ section of the ejection head according to the first exemplary embodiment;

FIG. 6 is an enlarged view of portion A of a pressure receiving portion in FIG. 4 according to the first exemplary embodiment;

FIG. 7 is a diagram illustrating an example of a configuration of a pressure receiving portion in the related art;

FIG. 8 is a diagram illustrating an example of a configuration of a pressure receiving portion according to a first modification;

FIG. 9 is a diagram illustrating an example of a configuration of a pressure receiving portion according to a second modification;

FIG. 10 is a diagram illustrating an example of a configuration of a pressure receiving portion according to a third modification;

FIG. 11 is a diagram illustrating an example of a configuration of a pressure receiving portion according to a fourth modification;

FIG. 12 is an enlarged view of portion B of a pressure receiving portion in FIG. 4 according to a second exemplary embodiment;

FIG. 13 is a schematic diagram illustrating an example of a degree of deformation of a piezoelectric element according to the second exemplary embodiment;

FIG. 14 is a diagram illustrating an example of a chamfered portion of the piezoelectric element according to the second exemplary embodiment;

FIG. 15 is a diagram illustrating an example of the chamfered portion of the piezoelectric element according to the second exemplary embodiment;

FIG. 16 is a diagram illustrating a pressure receiving portion and a piezoelectric element according to a third exemplary embodiment;

FIG. 17 is a diagram illustrating the pressure receiving portion and the piezoelectric element according to the third exemplary embodiment;

FIG. 18 is a diagram illustrating the pressure receiving portion and the piezoelectric element according to the third exemplary embodiment; and

FIG. 19 is a diagram illustrating a pressure receiving portion and a piezoelectric element in the related art.

### DETAILED DESCRIPTIONS

Hereinafter, exemplary embodiments of the present disclosure will be described in detail with reference to the drawings as appropriate. However, unnecessarily details may not be described. For example, a detailed description of an already well-known matter and a duplicated description of substantially the same configuration will be omitted in some cases. This is to avoid an unnecessarily redundant description below and to facilitate understanding of a person skilled in the art.

Note that, the accompanying drawings and the following description are provided for those skilled in the art to fully understand the present disclosure, and are not intended to limit the subject matter described in the scope of claims.

### First Exemplary Embodiment

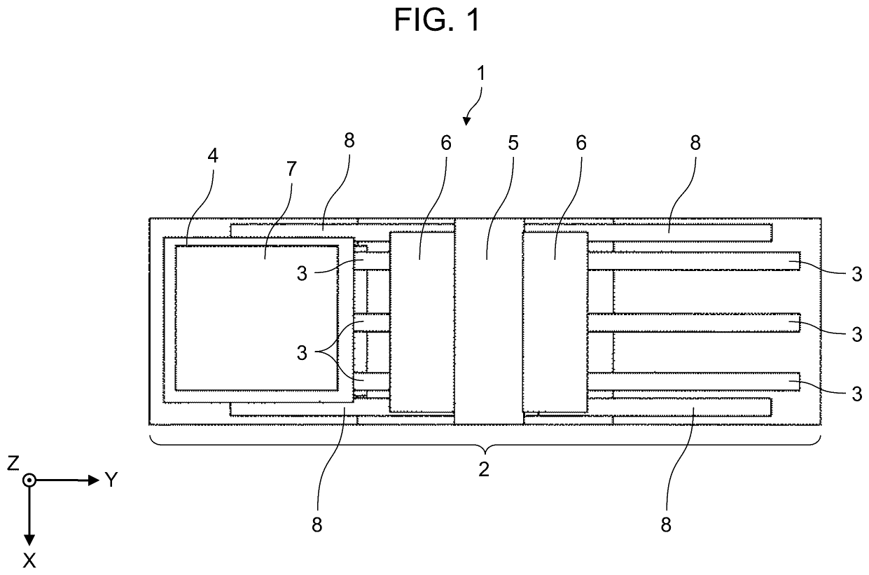

Inkjet device 1 will be described with reference to FIG. 1. FIG. 1 is a plan view of inkjet device 1 according to a first exemplary embodiment. As illustrated in FIG. 1, a lateral direction of inkjet device 1 is an X direction, a longitudinal direction is a Y direction, and a direction perpendicular to the X direction and the Y direction is a Z direction.

Inkjet device 1 includes base 2, guide 3, conveyance table 4, gantry 5 having a gate shape as an example of a support member, line head 6, and drive unit 8.

Base 2 is formed in a rectangular parallelepiped having a rectangular planar shape elongated in a scanning direction.

Guide 3 is fixed to an upper surface of base 2 along a longitudinal direction (Y direction) of base 2, that is, the scanning direction. As an example, guide 3 is made of a rectangular parallelepiped member having a rectangular section along a direction orthogonal to the scanning direction.

Conveyance table 4 has a rectangular shape, and a lower surface (a surface on a −Z side) comes into contact with guide 3. Conveyance table 4 is guided by guide 3 and is conveyed in the scanning direction of base 2. Print object 7 such as a substrate is placed on conveyance table 4.

Gantry 5 has a gate shape, and is fixed at a predetermined position, for example, an intermediate position of base 2 to straddle base 2 in a lateral direction in plan view (as viewed from a +Z side).

Line head 6 is an example of an ejection head, and is supported by gantry 5. Line head 6 ejects ink toward conveyance table 4 according to a timing at which conveyance table 4 passes under line head 6. The ink is applied to an application region of print object 7 placed on conveyance table 4.

Note that, in this configuration, as illustrated in FIG. 1, line head 6 has a configuration in which two types of line heads 6 are disposed on both surfaces of gantry 5, but only one line head 6 may be disposed on gantry 5, or two gantries 5 may be disposed, and a total of four line heads 6 may be disposed on both surfaces of gantries 5. The configuration such as the number and disposition of line heads 6 may be changed according to processing desired to be performed by line head 6 with respect to print object 7.

In addition, in order to drive conveyance table 4 in the scanning direction, at least one or more drive units 8 are disposed on base 2 along the scanning direction and are coupled to conveyance table 4, and conveyance table 4 can be conveyed and driven in the scanning direction.

In FIG. 1, as an example of drive unit 8, two drive units 8 are disposed on base 2 along the scanning direction near both end portions in the lateral direction of inkjet device 1. Each drive unit 8 may be a linear motor, or may be a ball screw or the like coupled to a rotary motor. In this configuration, drive unit 8 using the linear motor is illustrated.

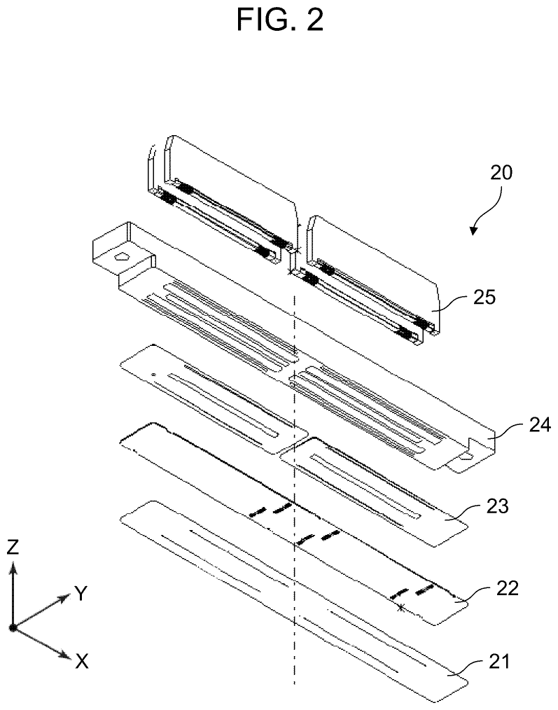

Ejection head 20 will be described with reference to FIG. 2. FIG. 2 is an exploded perspective view illustrating an appearance of ejection head 20 according to the first exemplary embodiment. As illustrated in FIG. 2, a longitudinal direction of ejection head 20 is defined as an X direction, a lateral direction is defined as a Y direction, and a direction perpendicular to the X direction and the Y direction is defined as a Z direction.

As illustrated in FIG. 2, ejection head 20 includes nozzle plate 21, channel plate 22, diaphragm 23, housing 24, and pressure fluctuation unit 25.

Nozzle plate 21 is disposed such that a plate surface is orthogonal to the Z direction. Nozzle plate 21 is manufactured by using a stainless steel plate molded by etching or press working, for example. A thickness of the stainless steel plate is, for example, 100 micrometers. In nozzle plate 21, nozzles 34 for ejecting inks are formed along the Y direction.

Channel plate 22 has a rectangular parallelepiped shape, and is disposed on a +Z side of nozzle plate 21 such that a plate surface is orthogonal to the Z direction. Channel plate 22 is sandwiched between diaphragm 23 and nozzle plate 21. Channel plate 22 is a stacked body of stainless steel plates molded by etching or press working, for example. Each of the stainless steel plates has a thickness in a range from 10 micrometers to 100 micrometers, inclusive, for example, and three to ten layers of the stainless steel plates are formed, for example.

Diaphragm 23 is disposed on a +Z side of channel plate 22 such that a plate surface is orthogonal to the Z direction. Diaphragm 23 is sandwiched between housing 24 and channel plate 22. Diaphragm 23 is, for example, a thin film having a thickness of 5 micrometers to 50 micrometers, and is manufactured by, for example, electroplating of a nickel alloy.

Housing 24 has a rectangular parallelepiped shape and is disposed on a +Z side of diaphragm 23. Housing 24 has a thickness of 1 centimeter in the Z direction, for example. Housing 24 is manufactured by cutting alloy steel such as stainless steel, for example.

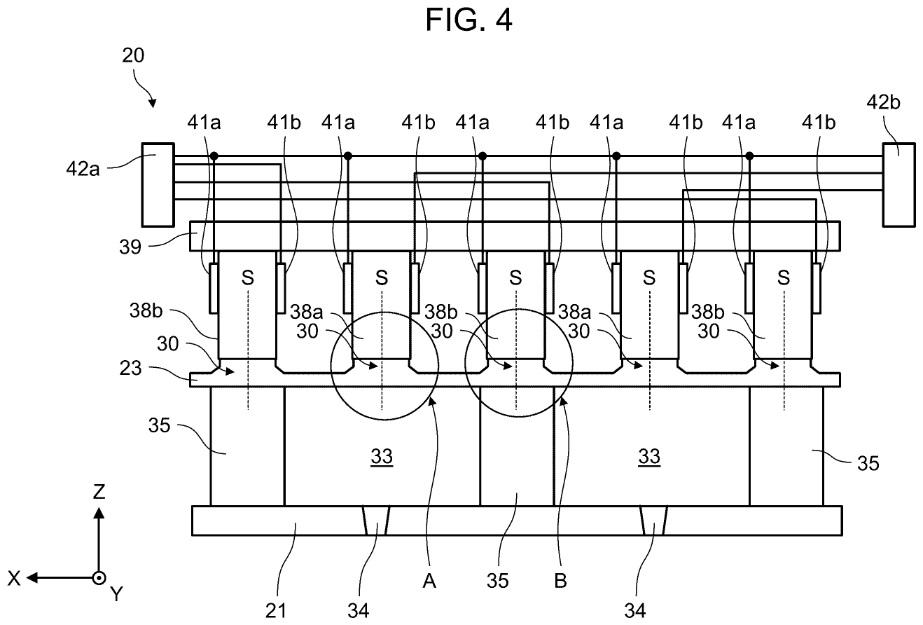

Pressure fluctuation unit 25 is housed in housing 24 and pressurizes inks stored in pressure chambers 33 to generate pressure fluctuation. Pressure fluctuation unit 25 includes, for example, a control board on which a control IC and the like are implemented, and the control board individually controls voltages applied to first piezoelectric elements 38a and second piezoelectric elements 38b illustrated in FIG. 4 and the like.

A space between nozzle plate 21 and channel plate 22, a space between channel plate 22 and diaphragm 23, a space between diaphragm 23 and housing 24, and a space between diaphragm 23 and pressure fluctuation unit 25 are bonded and fixed with an adhesive. Available examples of the adhesive include an epoxy-based adhesive having thermosetting characteristics. Note that, the adhesives for bonding the respective components may be identical or different. For example, a rubber-based adhesive and an epoxy-based adhesive may be used in combination.

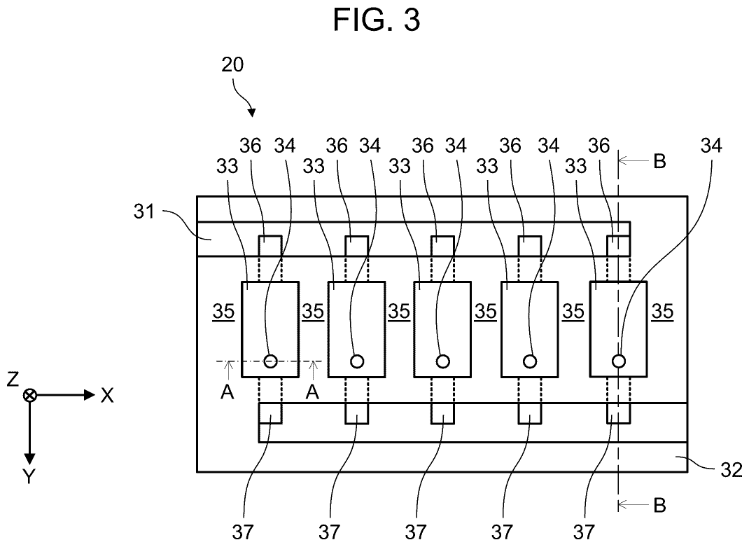

A schematic configuration of ejection head 20 will be described with reference to FIG. 3. FIG. 3 is a diagram illustrating an example of a configuration of ejection head 20 according to the first exemplary embodiment.

Ejection head 20 includes ink supply channel 31, ink discharge channel 32, pressure chambers 33, nozzles 34, partition walls 35, ink inlet channels 36, and ink outlet channels 37.

Ink supply channel 31 and ink discharge channel 32 are disposed along the X direction of ejection head 20. In addition, ink supply channel 31 and ink discharge channel 32 are disposed to face each other in the Y direction of ejection head 20.

Pressure chambers 33 are disposed between ink supply channel 31 and ink discharge channel 32. A plurality of pressure chambers 33 are disposed in the X direction.

The ink supplied to ink supply channel 31 is supplied to pressure chamber 33 via ink inlet channel 36 communicating with pressure chamber 33 from a negative pressure generated in pressure chamber 33 when first piezoelectric element 38a and second piezoelectric element 38b contract from an extended state. A part of the ink supplied to pressure chamber 33 is ejected from nozzle 34 by pressurization to pressure chamber 33 by extension of first piezoelectric element 38a and second piezoelectric element 38b, and the rest is discharged to ink discharge channel 32 via ink outlet channel 37 communicating with pressure chamber 33. The ink in ink discharge channel 32 is supplied to ink supply channel 31 again.

Nozzle 34 is a through-hole provided in nozzle plate 21, and communicates an inside and an outside of pressure chamber 33. Nozzle 34 is provided to correspond to pressure chamber 33. In addition, the ink is ejected from nozzle 34 in a −Z direction.

In addition, nozzle 34 is provided on ink outlet channel 37 side (+Y side) of pressure chamber 33 in the Y direction. Such a configuration is effective for smoothly ejecting the ink from nozzle 34 and discharging the ink to ink outlet channel 37.

A plurality of partition walls 35 are disposed in the X direction. Partition wall 35 separates pressure chamber 33 that stores the ink ejected from nozzle 34.

A schematic configuration of ejection head 20 in an XZ section will be described with reference to FIG. 4. FIG. 4 is a diagram (for example, a sectional view taken along line A-A in FIG. 3) illustrating an example of the XZ section of ejection head 20 according to the first exemplary embodiment.

Pressure chamber 33 includes nozzle plate 21, partition wall 35, and diaphragm 23. Nozzle plate 21 constitutes a lower (−Z side) wall of pressure chamber 33. Partition wall 35 constitutes left (+X side) and right (−X side) walls of pressure chamber 33. Diaphragm 23 constitutes an upper (+Z side) wall of pressure chamber 33.

A plurality of first piezoelectric elements 38a and a plurality of second piezoelectric elements 38b are alternately disposed in the X direction. First piezoelectric element 38a is disposed in a portion of diaphragm 23 corresponding to pressure chamber 33. First piezoelectric element 38a presses the portion of diaphragm 23 corresponding to pressure chamber 33.

Second piezoelectric element 38b is disposed in a portion of diaphragm 23 corresponding to partition wall 35. Second piezoelectric element 38b supports the portion of diaphragm 23 corresponding to partition wall 35.

Base portion 39 fixes the plurality of first piezoelectric elements 38a and the plurality of second piezoelectric elements 38b disposed in the X direction on a side opposite to diaphragm 23. For example, base portion 39 has the same composition as first piezoelectric element 38a and second piezoelectric element 38b, and is integrally molded with first piezoelectric element 38a and second piezoelectric element 38b.

Diaphragm 23 includes a pressure receiving portion 30 that receives pressures from first piezoelectric element 38a and second piezoelectric element 38b. Pressure receiving portion 30 protrudes from a body of diaphragm 23 and comes into contact with first piezoelectric element 38a and second piezoelectric element 38b. Pressure receiving portion 30 may be referred to as a convex portion, a protruding portion, or a projecting portion.

Center S of pressure receiving portion 30 in the X direction preferably coincides with centers of first piezoelectric element 38a and second piezoelectric element 38b in the X direction. In addition, a distance between centers of adjacent pressure receiving portions 30 in the X direction is preferably the same as a distance between centers of adjacent first piezoelectric element 38a and second piezoelectric element 38b.

Common electrodes 41a are provided in first piezoelectric element 38a and second piezoelectric element 38b. Common electrodes 41a are electrically connected to direction control circuit 42a. Individual electrodes 41b are provided in first piezoelectric element 38a and second piezoelectric element 38b. Individual electrodes 41b are electrically connected to drive circuit 42b.

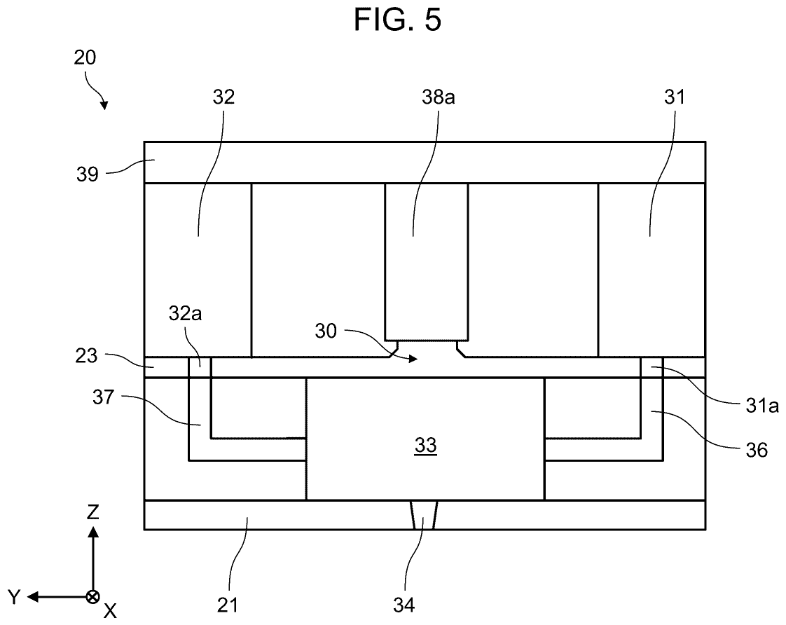

A schematic configuration of ejection head 20 in a YZ section will be described with reference to FIG. 5. FIG. 5 is a diagram (for example, a sectional view taken along line B-B in FIG. 3) illustrating an example of the YZ section of the ejection head according to the first exemplary embodiment.

As illustrated in FIG. 5, ink supply channel 31 and ink discharge channel 32 are provided on first piezoelectric element 38a side (+Z side) of diaphragm 23.

Ink inlet channel 36 and ink outlet channel 37 are provided on pressure chamber 33 side (−Z side) of diaphragm 23.

Ink supply channel 31 and ink inlet channel 36 communicate with each other via hole 31a provided in diaphragm 23, and the ink supplied to ink supply channel 31 passes through ink inlet channel 36 via hole 31a and is supplied to pressure chamber 33.

Ink discharge channel 32 and ink outlet channel 37 communicate with each other via hole 32a provided in diaphragm 23, and the ink discharged from pressure chamber 33 to ink outlet channel 37 passes through ink discharge channel 32 via hole 32a and is discharged from ejection head 20.

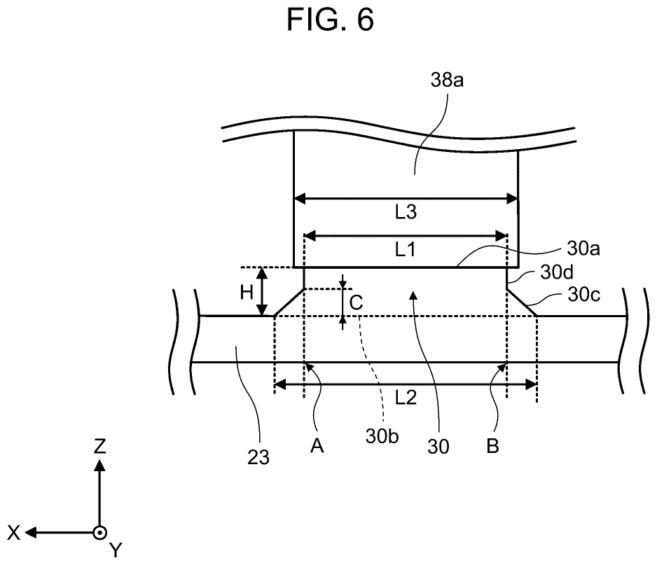

A contact portion between pressure receiving portion 30 and first piezoelectric element 38a will be described with reference to FIG. 6. FIG. 6 is an enlarged view of portion A of pressure receiving portion 30 in FIG. 4 according to the first exemplary embodiment.

Pressure receiving portion 30 includes top portion 30a, base portion 30b, first portion 30c, and second portion 30d.

Top portion 30a is an upper surface (a surface on a +Z side) of pressure receiving portion 30 that comes into contact with first piezoelectric element 38a and protrudes from the body of diaphragm 23. Width L3 of first piezoelectric element 38a in the X direction is larger than width L1 of top portion 30a in the X direction (L3>L1).

Note that, the width of first piezoelectric element 38a may be larger than the width of top portion 30a in other directions on an XY plane. In other words, in at least one direction perpendicular to the Z direction in which first piezoelectric element 38a presses diaphragm 23, the width of first piezoelectric element 38a is larger than the width of top portion 30a.

In a case where first piezoelectric element 38a is deformed by application of a voltage, top portion 30a is pressed in the −Z direction by first piezoelectric element 38a, and diaphragm 23 is deformed. Deformed diaphragm 23 presses pressure chamber 33 in the −Z direction. That is, first piezoelectric element 38a presses pressure chamber 33 in the −Z direction via diaphragm 23. Pressure chamber 33 is pressed in the −Z direction in this manner, and the ink stored in pressure chamber 33 is ejected from nozzle 34 in the −Z direction.

In addition, since width L3 of first piezoelectric element 38a in the X direction is larger than width L1 of top portion 30a in the X direction (L3>L1), stress is uniformly applied to entire top portion 30a when first piezoelectric element 38a is deformed. As a result, since the deformation of diaphragm 23 is stabilized, a change in pressure of pressure chamber 33 is stabilized. Thus, the ejection of the ink of inkjet device 1 is stabilized.

Base portion 30b corresponds to a portion connecting pressure receiving portion 30 and the body of diaphragm 23.

Pressure receiving portion 30 includes first portion 30c having a width that gradually increases from the width of top portion 30a and reaches the width of base portion 30b, and second portion 30d in which a width of pressure receiving portion 30 is the same as the width of top portion 30a on first piezoelectric element 38a side with respect to first portion 30c. That is, pressure receiving portion 30 has a stepped portion between top portion 30a and base portion 30b, and has a tapered inclined surface expanding outward from the stepped portion to base portion 30b.

In the X direction, width L1 of top portion 30a in the X direction is smaller than width L2 of base portion 30b in the X direction (L1<L2).

Note that, the width of top portion 30a may be smaller than the width of base portion 30b in other directions on the XY plane. In other words, in at least one direction perpendicular to the Z direction in which first piezoelectric element 38a presses diaphragm 23, the width of top portion 30a is smaller than the width of base portion 30b.

In addition, in a case where lengths of top portion 30a and base portion 30b of pressure receiving portion 30 in the Z direction are H, height C of first portion 30c in the Z direction is preferably from 0.01H to H inclusive.

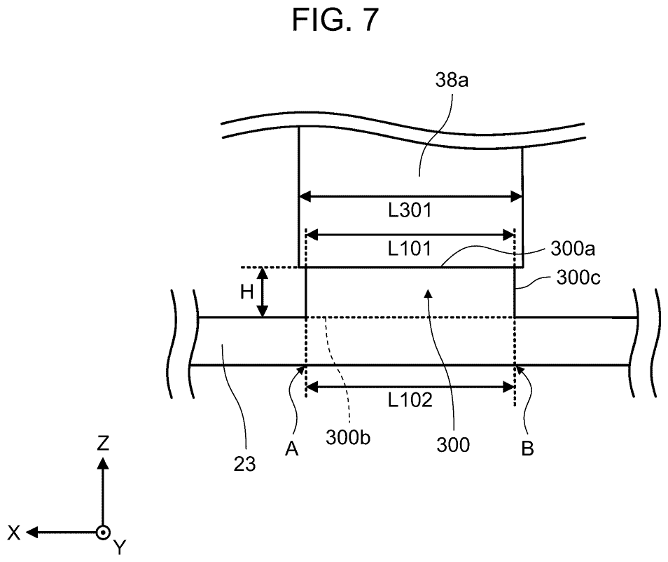

Comparison between pressure receiving portion 300 of the related art and pressure receiving portion 30 of the first exemplary embodiment will be described with reference to FIG. 7. FIG. 7 is a diagram illustrating an example of a configuration of pressure receiving portion 300 in the related art.

Unlike pressure receiving portion 30 of the first exemplary embodiment, pressure receiving portion 300 has no tapered inclined surface between top portion 300a and base portion 300b, and a surface of the body of diaphragm 23 and a side surface of pressure receiving portion 300 intersect at a right angle. That is, width L101 of top portion 30a in the X direction is equal to width L102 of base portion 300b in the X direction (L101=L102).

In a case where diaphragm 23 including pressure receiving portion 300 of the related art is deformed, in pressure receiving portion 300, stress tends to concentrate on portions A and B as compared with the case of the first exemplary embodiment, and there is a possibility that a resistance of diaphragm 23 against degradation or damage due to the deformation decreases. In addition, the ejection of the ink of inkjet device 1 becomes unstable, and there is a possibility that print quality deteriorates.

In the first exemplary embodiment, since pressure receiving portion 30 has the tapered inclined surface on the side surface thereof, stress concentration on portions A and B of diaphragm 23 is alleviated. As a result, a resistance of diaphragm 23 against the deterioration or damage due to deformation increases.

### (First Modification)

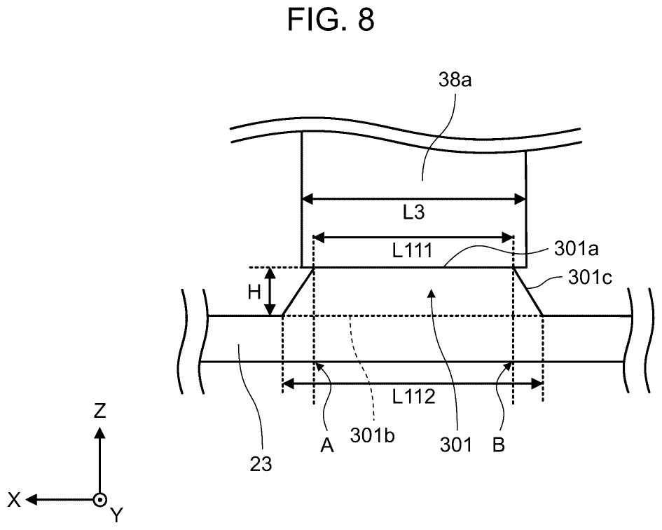

Pressure receiving portion 301 of a first modification will be described with reference to FIG. 8. FIG. 8 is a diagram illustrating an example of a configuration of pressure receiving portion 301 according to the first modification.

Pressure receiving portion 301 includes top portion 301a, base portion 301b, and first portion 301c. Top portion 301a and base portion 301b are similar to top portion 30a and base portion 30b according to the first exemplary embodiment.

Unlike pressure receiving portion 30 of the first exemplary embodiment, pressure receiving portion 301 of the first modification has no stepped portion between top portion 301a and base portion 301b, and has first portion 301c having a width gradually increases from a width of top portion 301a and reaches a width of base portion 301b. First portion 301c linearly increases toward base portion 301b.

That is, pressure receiving portion 301 has a tapered inclined surface expanding outward from top portion 301a to base portion 301b. As a result, width L111 of top portion 301a in the X direction becomes shorter than width L112 of base portion 301b in the X direction (L111<L112).

Note that, the width of top portion 301a may be smaller than the width of base portion 301b in other directions on the XY plane. In other words, in at least one direction perpendicular to the Z direction in which first piezoelectric element 38a presses diaphragm 23, the width of top portion 301a is smaller than the width of base portion 301b.

In the first modification, similarly to the first exemplary embodiment, since pressure receiving portion 301 has a structure in which stress concentration on portions A and B is alleviated when the pressure receiving portion is pressed by first piezoelectric element 38a, an effect similar to that of the first exemplary embodiment can be obtained also in the first modification.

### (Second Modification)

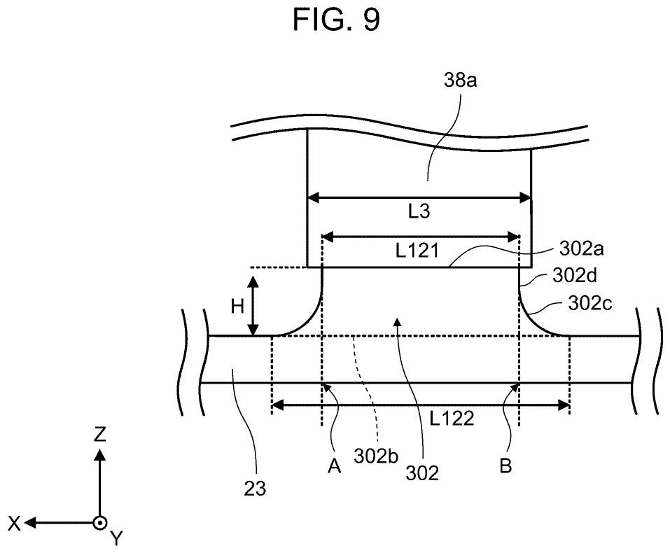

Pressure receiving portion 302 of a second modification will be described with reference to FIG. 9. FIG. 9 is a diagram illustrating an example of a configuration of pressure receiving portion 302 according to the second modification.

Pressure receiving portion 302 includes top portion 302a, base portion 302b, first portion 302c, and second portion 302d. top portion 302a and base portion 302b are similar to top portion 30a and base portion 30b according to the first exemplary embodiment.

Similarly to pressure receiving portion 30 of the first exemplary embodiment, pressure receiving portion 302 of the second modification includes first portion 302c having a width gradually increases from a width of top portion 302a and reaches a width of base portion 302b, and second portion 302d in which a width of pressure receiving portion 302 is the same as the width of top portion 302a on first piezoelectric element 38a side with respect to first portion 302c. A width of first portion 302c increases in a curved manner toward base portion 302b.

That is, pressure receiving portion 302 has a curved surface expanding outward from top portion 302a to base portion 302b. Thus, width L121 of top portion 302a in the X direction is smaller than width L122 of base portion 302b in the X direction (L121<L122).

Note that, the width of top portion 302a may be smaller than the width of base portion 302b in other directions on the XY plane. In other words, in at least one direction perpendicular to the Z direction in which first piezoelectric element 38a presses diaphragm 23, the width of top portion 302a is smaller than the width of base portion 302b.

In addition, in a case where a contour of a section of a side surface of second portion 302d illustrated in FIG. 9 is an arc, a radius of curvature of the arc is preferably from 0.01H to H inclusive. Note that, in a case where the radius of curvature of the arc is H, first portion 302c is not present.

In the second modification, similarly to the first exemplary embodiment, since pressure receiving portion 302 has a structure in which stress concentration on portions A and B is alleviated when the pressure receiving portion is pressed by first piezoelectric element 38a, an effect similar to that of the first exemplary embodiment can be obtained also in the second modification.

### (Third Modification)

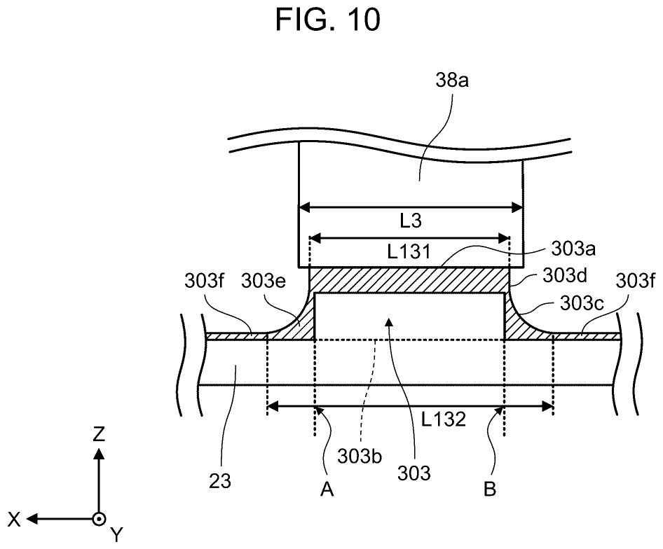

Pressure receiving portion 303 of a third modification will be described with reference to FIG. 10. FIG. 10 is a diagram illustrating an example of a configuration of pressure receiving portion 303 according to the third modification.

Pressure receiving portion 303 of the third modification includes film 303e on first piezoelectric element 38a side of diaphragm 23. In addition, diaphragm 23 has film 303f having a uniform thickness on both surfaces of film 303e. Films 303e and 303f function as protective films for protecting diaphragm 23.

Pressure receiving portion 303 includes top portion 303a, base portion 303b, first portion 303c, and second portion 303d. Top portion 303a is similar to top portion 30a according to the first exemplary embodiment. Base portion 303b corresponds to a portion connecting film 303e and the body of pressure receiving portion 303 to the body of diaphragm 23.

As in the second modification, film 303e of pressure receiving portion 303 has first portion 303c having a width gradually increases from a width of top portion 303a and reaches a width of base portion 303b, and second portion 303d in which a width of pressure receiving portion 303 is the same as the width of top portion 303a on first piezoelectric element 38a side with respect to first portion 303c. A width of first portion 303c increases in a curved manner toward base portion 303b.

Pressure receiving portion 303 has a curved surface expanding outward from top portion 303a to base portion 303b. Thus, width L131 of top portion 303a in the X direction is smaller than width L132 of base portion 303b in the X direction (L131<L132).

Note that, the width of top portion 303a may be smaller than the width of base portion 303b in other directions on the XY plane. In other words, in at least one direction perpendicular to the Z direction in which first piezoelectric element 38a presses diaphragm 23, the width of top portion 303a is smaller than the width of base portion 303b.

Film 303e is formed by, for example, chemical vapor deposition (CVD), physical vapor deposition (PVD), or the like by using an inorganic material and an organic material.

For example, an inorganic material such as SiO₂ (silicon dioxide), Al₂O₃ (aluminum oxide), or TiO₂ (titanium oxide), or an organic material such as parylene is used for film 303e. In addition, a film thickness of film 303e is preferably from 0.05 micrometers to 5 micrometers inclusive.

In addition, in a case where a contour of a section of a side surface of second portion 302d illustrated in FIG. 10 is an arc, a radius of curvature of the arc is preferably from 0.01H to H inclusive. Note that, in a case where the radius of curvature of the arc is H, first portion 303c is not present.

In the third modification, as in the first exemplary embodiment, pressure receiving portion 303 can alleviate stress concentration on portions A and B when the pressure receiving portion is pressed by first piezoelectric element 38a.

In the third modification, similarly to the first exemplary embodiment, since pressure receiving portion 303 has a structure in which stress concentration on portions A and B is alleviated when the pressure receiving portion is pressed by first piezoelectric element 38a, an effect similar to that of the first exemplary embodiment can be obtained also in the third modification.

### (Fourth Modification)

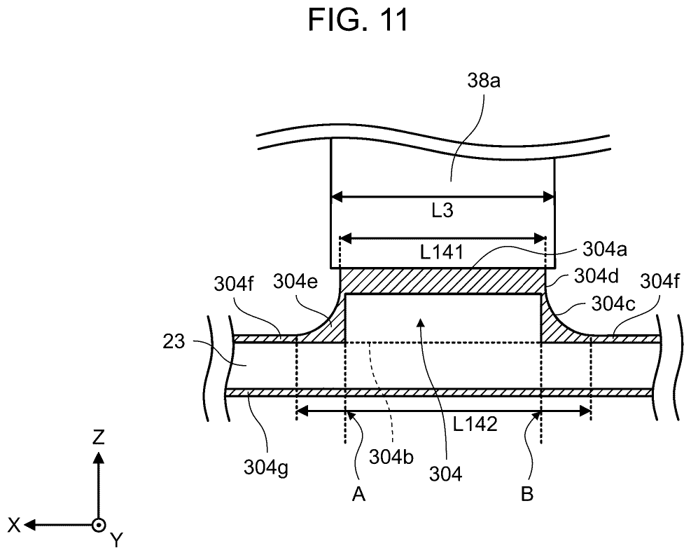

Pressure receiving portion 304 of a fourth modification will be described with reference to FIG. 11. FIG. 11 is a diagram illustrating an example of a configuration of pressure receiving portion 304 according to the fourth modification.

Pressure receiving portion 304 of the fourth modification has films 304e and 304f on first piezoelectric element 38a side of diaphragm 23, and has film 304g on pressure chamber 33 side of diaphragm 23. Film 304e and film 304f are similar to those in the third modification, and function as protective films for protecting diaphragm 23.

As in the third modification, film 304e of pressure receiving portion 304 has first portion 304c having a width gradually increases from a width of top portion 304a and reaches a width of base portion 304b, and second portion 304d in which a width of pressure receiving portion 304 is the same as the width of top portion 304a on first piezoelectric element 38a side with respect to first portion 304c. A width of first portion 304c increases in a curved manner toward base portion 304b.

As in the second modification, film 304e of pressure receiving portion 304 has first portion 304c having a width increases toward base portion 304b and whose side surface is a curved surface, and second portion 304d whose width is constant toward base portion 304b. Width L141 of top portion 304a in the X direction is smaller than width L142 of base portion 304b in the X direction (L141<L142).

Note that, the width of top portion 304a may be smaller than the width of base portion 304b in other directions on the XY plane. In other words, in at least one direction perpendicular to the Z direction in which first piezoelectric element 38a presses diaphragm 23, the width of top portion 304a is smaller than the width of base portion 304b.

In addition, as in the third modification, film 304e, film 304f, and film 304g are formed by CVD, PVD, or the like by using an inorganic material and an organic material.

In the fourth modification, similarly to the first exemplary embodiment, since pressure receiving portion 304 has a structure in which stress concentration on portions A and B is alleviated when the pressure receiving portion is pressed by first piezoelectric element 38a, an effect similar to that of the first exemplary embodiment can be obtained also in the fourth modification.

### Second Exemplary Embodiment

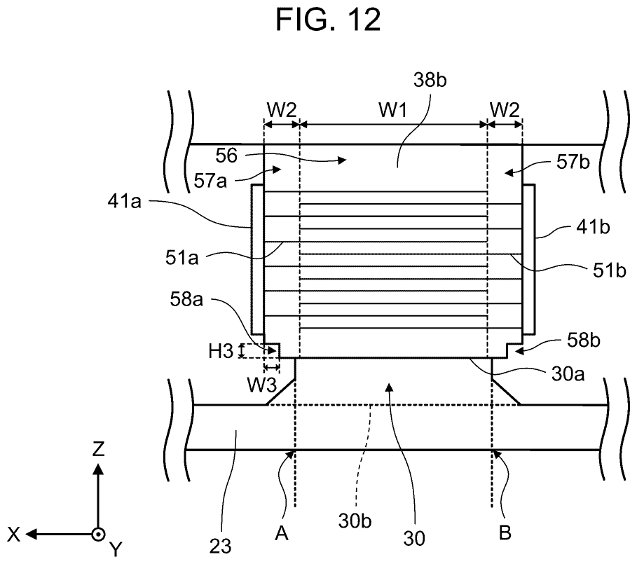

Second piezoelectric element 38b disposed above partition wall 35 will be described with reference to FIG. 12. FIG. 12 is an enlarged view of part B in FIG. 4. A second exemplary embodiment is different from the first exemplary embodiment in a configuration of second piezoelectric element 38b that supports partition wall 35 via a diaphragm 23.

Second piezoelectric element 38b includes common electrode 41a and individual electrode 41b. First wiring 51a is electrically connected to common electrode 41a (first electrode), and second wiring 51b is electrically connected to individual electrode 41b (second electrode).

Common electrode 41a applies voltage Va to second piezoelectric element 38b via first wiring 51a, and individual electrode 41b applies voltage Vb lower than voltage Va to second piezoelectric element 38b via second wiring 51b. For example, voltage Va may be +V1 volt, and voltage Vb may be −V1 volt. First wiring 51a and second wiring 51b are connected to electrodes having different polarities.

In addition, second piezoelectric element 38b includes movable portion 56, first end portion 57a, and second end portion 57b.

Movable portion 56 is a portion near a center of second piezoelectric element 38b, and includes both first wiring 51a electrically connected to common electrode 41a and second wiring 51b electrically connected to individual electrode 41b. In movable portion 56, first wiring 51a and second wiring 51b are alternately disposed in the Z direction.

Thus, when voltage Va and voltage Vb are applied to common electrode 41a and individual electrode 41b, electric polarization is generated in movable portion 56 due to a potential difference generated between first wiring 51a and second wiring 51b. Due to this electric polarization, movable portion 56 is deformed. That is, movable portion 56 of second piezoelectric element 38b is deformed when voltage Va and voltage Vb are applied to common electrode 41a and individual electrode 41b.

First end portion 57a is a portion of second piezoelectric element 38b on the end portion side on common electrode 41a side, and includes first wiring 51a electrically connected to common electrode 41a. First end portion 57a does not include second wiring 51b electrically connected to individual electrode 41b. Thus, when voltage Va and voltage Vb are applied to common electrode 41a and individual electrode 41b, since electric polarization is not generated in first end portion 57a, first end portion 57a is not greatly deformed although the first end portion is somewhat affected by the deformation of movable portion 56.

Second end portion 57b is a portion of second piezoelectric element 38b on the end portion side on individual electrode 41b side, and includes second wiring 51b electrically connected to individual electrode 41b. Second end portion 57b does not include first wiring 51a electrically connected to common electrode 41a. Thus, when voltage Va and voltage Vb are applied to common electrode 41a and individual electrode 41b, since electric polarization is not generated in second end portion 57b, second end portion 57b is not greatly deformed although the second end portion is somewhat affected by the deformation of movable portion 56.

End portion regions (first end portion 57a and second end portion 57b) of second piezoelectric element 38b are regions that are hardly deformed when voltage Va and voltage Vb are applied to common electrode 41a and individual electrode 41b.

In addition, second piezoelectric element 38b has the end portion regions (first end portion 57a and second end portion 57b) in the X direction. Note that, second piezoelectric element 38b may have an end portion region that is not driven in other directions on the XY plane. In other words, second piezoelectric element 38b has an end portion region that is not driven in at least one direction perpendicular to the Z direction in which diaphragm 23 is pressed. Second piezoelectric element 38b has a central region (movable portion 56) in the X direction and end portion regions (first end portion 57a and second end portion 57b) adjacent to the central region (movable portion 56) in the X direction. The central region (movable portion 56) includes both first wiring 51a and second wiring 51b. The central region (movable portion 56) receives a voltage applied between common electrode 41a and individual electrode 41b of second piezoelectric element 38b through first wiring 51a and second wiring 51b. On the other hand, the end portion regions (first end portion 57a and second end portion 57b) include only one of first wiring 51a and second wiring 51b. Since the end portion regions (first end portion 57a and second end portion 57b) include only one of first wiring 51a and second wiring 51b, the end portion regions do not receive a voltage applied between common electrode 41a and individual electrode 41b of second piezoelectric element 38b.

In addition, first end portion 57a and second end portion 57b have first chamfered portion 58a and second chamfered portion 58b having a stepped shape at corner portions of first end portion 57a and second end portion 57b on diaphragm 23 side.

Since the corner portion on diaphragm 23 side has a step shape, first end portion 57a and second end portion 57b are hardly deformed, and stress concentration on portions A and B can be alleviated.

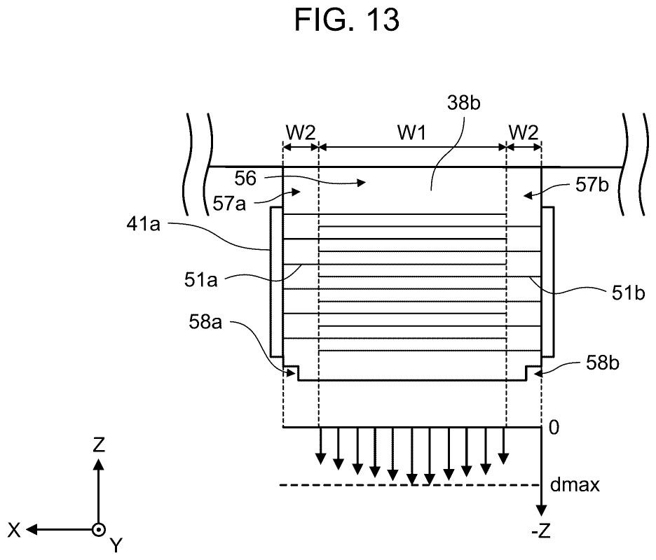

The deformation of second piezoelectric element 38b when voltage Va and voltage Vb are applied to common electrode 41a and individual electrode 41b will be described in more detail with reference to FIG. 13. FIG. 13 is a schematic diagram illustrating an example of a degree of deformation of the piezoelectric element according to the second exemplary embodiment.

In FIG. 13, magnitude d of deformation of second piezoelectric element 38b is indicated by a length of an arrow. As magnitude d of deformation of second piezoelectric element 38b increases, the length of the arrow increases. In addition, the deformation of second piezoelectric element 38b in the −Z direction is defined as plus.

In movable portion 56 of second piezoelectric element 38b, magnitude d of deformation of second piezoelectric element 38b decreases from near the center to the end portion region. Near the center of movable portion 56, magnitude d of deformation of second piezoelectric element 38b is the maximum, and this maximum value is defined as dmax.

On the other hand, since the end portion region of second piezoelectric element 38b is hardly deformed, the end portion region functions as a fixed end.

A distribution of the magnitude of deformation is set to such a distribution, and thus, it is possible to alleviate stress concentration on portions A and B illustrated in FIG. 13. Further, since first end portion 57a and second end portion 57b have first chamfered portion 58a and second chamfered portion 58b, first end portion 57a and second end portion 57b can be further hardly deformed, and stress concentration on portions A and B can be further alleviated.

Note that, when a width of movable portion 56 in the X direction is W1, W1 is preferably from 500 micrometers to 2000 micrometers inclusive.

When widths of first end portion 57a and second end portion 57b in the X direction are W2, W2 is preferably from 100 micrometers to 200 micrometers inclusive.

When chamfered widths of first chamfered portion 58a and second chamfered portion 58b in the X direction are W3, W3 is preferably from 20 micrometers to 100 micrometers inclusive.

When chamfered heights of first chamfered portion 58a and second chamfered portion 58b in the Z direction are H3, H3 is preferably from 20 micrometers to 200 micrometers inclusive.

Maximum value dmax of magnitude d of deformation of second piezoelectric element 38b is preferably from 0.2 micrometers to 2 micrometers inclusive.

In addition, W2/dmax is preferably from 100 to 1000 inclusive, and W2/W3 is preferably from 1 to 10 inclusive.

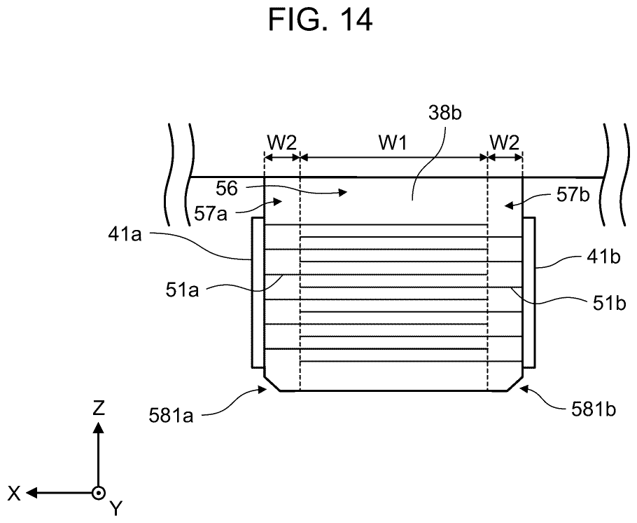

Note that, as illustrated in FIG. 14, first end portion 57a and second end portion 57b may have linear first chamfered portions 581a and second chamfered portions 581b at corner portions of first end portion 57a and second end portion 57b on diaphragm 23 side.

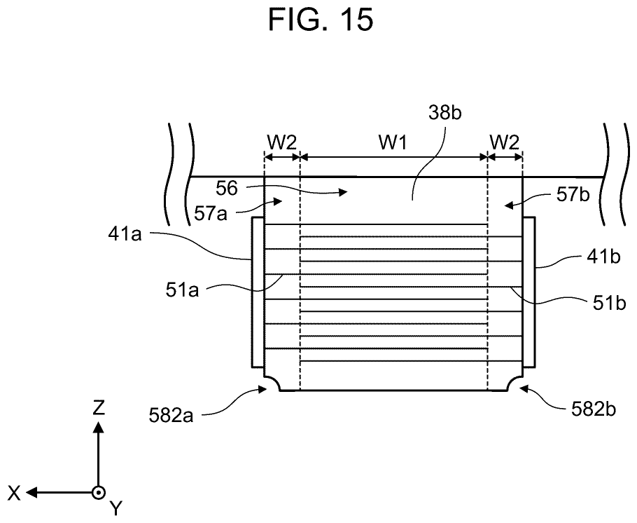

In addition, as illustrated in FIG. 15, first end portion 57a and second end portion 57b may have arc-shaped first chamfered portion 582a and arc-shaped second chamfered portion 582b at corner portions of first end portion 57a and second end portion 57b on diaphragm 23 side.

Even though a shape of the corner portion is such a shape, first end portion 57a and second end portion 57b are hardly deformed, and stress concentration on portions A and B can be alleviated.

Note that, in the second exemplary embodiment, second piezoelectric element 38b has first end portion 57a and second end portion 57b that are not driven, but first piezoelectric element 38a illustrated in FIG. 4 may have regions corresponding to first end portion 57a and second end portion 57b.

### Third Exemplary Embodiment

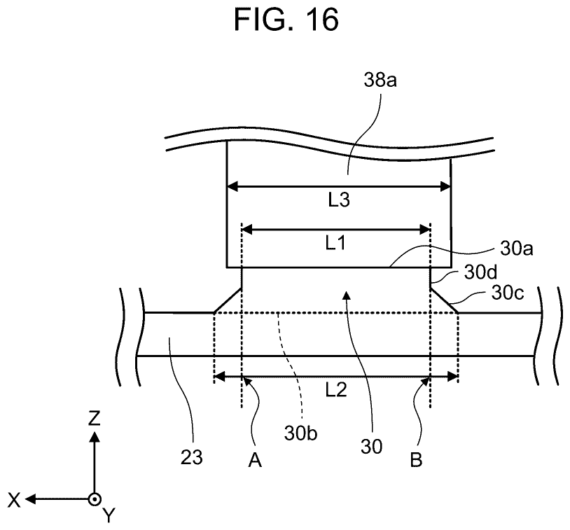

Contact between pressure receiving portion 30 and first piezoelectric element 38a will be described with reference to FIGS. 16 to 19. FIGS. 16 to 18 are diagrams illustrating pressure receiving portion 30 and first piezoelectric element 38a according to a third exemplary embodiment.

Since configurations of pressure receiving portion 30 and first piezoelectric element 38a of the third exemplary embodiment have the same structures as those of the first exemplary embodiment, the description of the structures of pressure receiving portion 30 and first piezoelectric element 38a will be omitted.

In the third exemplary embodiment, as in the first exemplary embodiment (see, for example, FIG. 6), first piezoelectric element 38a comes into contact with top portion 30a of pressure receiving portion 30.

Note that, the width of top portion 30a may be smaller than the width of first piezoelectric element 38a in the X direction in other directions on the XY plane. In other words, in at least one direction perpendicular to the Z direction in which first piezoelectric element 38a presses diaphragm 23, the width of top portion 30a is smaller than the width of first piezoelectric element 38a.

For example, in a case where a difference between L3 and L1 is difference d (d=L3−L1), difference d is preferably from 1 micrometer to 100 micrometers inclusive.

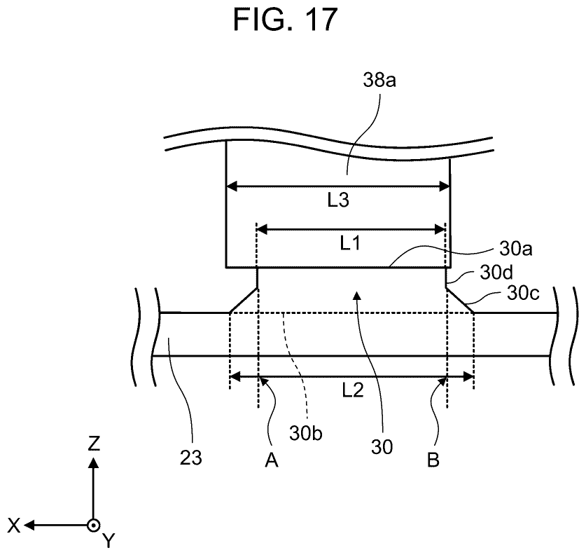

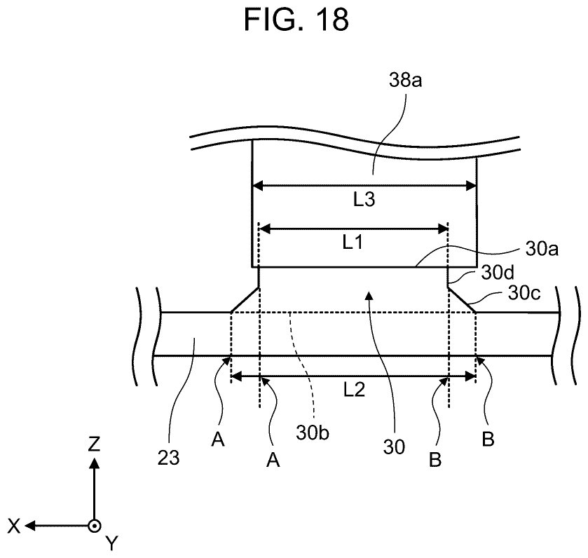

For example, as illustrated in FIG. 17, first piezoelectric element 38a may be displaced to a left side with respect to top portion 30a due to manufacturing variations of inkjet device 1. In addition, for example, as illustrated in FIG. 18, first piezoelectric element 38a may be displaced to a right side with respect to top portion 30a.

In any case of FIGS. 16 to 18, since a contact area between top portion 30a and first piezoelectric element 38a does not change, stress applied to top portion 30a by first piezoelectric element 38a does not change. Thus, the deformation of diaphragm 23 is stabilized, and a change in pressure of pressure chamber 33 is stabilized. Thus, the ejection of the ink of inkjet device 1 is stabilized.

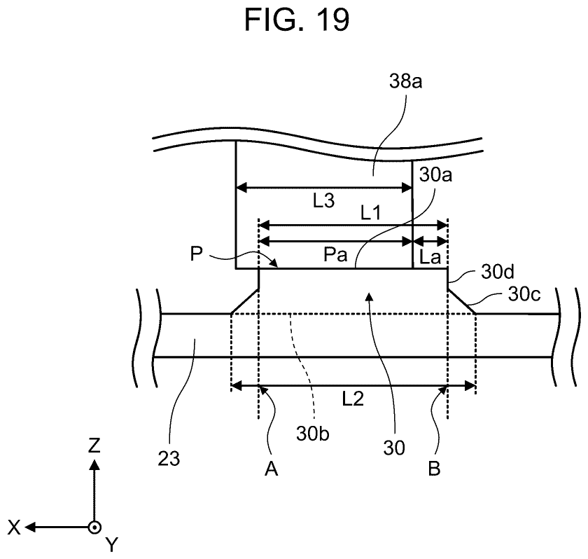

For example, as illustrated in FIG. 19, in a case where first piezoelectric element 38a is greatly displaced with respect to top portion 30a due to the manufacturing variations of inkjet device 1, an area of contact portion P where top portion 30a and first piezoelectric element 38a come into contact with each other becomes smaller than that in the case of FIGS. 16 to 18. In addition, width Pa of contact portion P in the X direction decreases by width La (Pa=L1−La).

Since a force applied by first piezoelectric element 38a is constant, when the area of contact portion P changes in this manner, the stress applied to diaphragm 23 is not uniform. As a result, a degree of stress concentration at portions A and B increases.

In the third exemplary embodiment, even in a case where first piezoelectric element 38a is displaced to some extent with respect to top portion 30a, since width L1 of top portion 30a in the X direction is smaller than width L3 of first piezoelectric element 38a in the X direction (L1<L3), inkjet device 1 has a structure capable of maintaining the area of contact portion P. Thus, inkjet device 1 can obtain an effect of alleviating the stress concentration on portions A and B of diaphragm 23.

### SUMMARY OF EXEMPLARY EMBODIMENTS

As described above, the inkjet device of the present exemplary embodiment includes the partition wall that separates the pressure chamber that stores the ink ejected from the nozzle, the piezoelectric element that presses the pressure chamber via the diaphragm, and the diaphragm that applies the pressure to the pressure chamber communicating with the nozzle that ejects the ink when the diaphragm is pressed by the piezoelectric element, in which the diaphragm includes the pressure receiving portion whose top portion comes into contact with the piezoelectric element and whose base portion is connected to the body of the diaphragm, and the width of the base portion is larger than the width of the top portion in at least one direction perpendicular to the direction in which the piezoelectric element presses the diaphragm.

With this configuration, when first piezoelectric element 38a and second piezoelectric element 38b to which the voltages are applied deform diaphragm 23, the stress concentration on portions A and B of diaphragm 23 is alleviated.

The expression, “ . . . part” used for each component in the above-described exemplary embodiments may be replaced with another expression such as “ . . . assembly”, “ . . . device”, “ . . . unit”, or “ . . . module”.

Although the exemplary embodiments have been described with reference to the accompanying drawings, the present disclosure is not limited to the examples. It is apparent that those skilled in the art could easily conceive of various changes or modifications within the scope of the claims. Such changes or modifications are also understood to belong to the technical scope of the present disclosure. In addition, within a range without departing from the gist of the present disclosure, the components in the exemplary embodiments may be combined as appropriate.

The present disclosure is useful as the inkjet device.

What is claimed is:

1. An inkjet device comprising:
a pressure chamber that stores ink;
a piezoelectric element that is away from the pressure chamber in a first direction; and
a diaphragm that is disposed between the pressure chamber and the piezoelectric element in the first direction,
wherein the diaphragm includes a pressure receiving portion, the pressure receiving portion including a top portion and a base portion,
the top portion is in contact with the piezoelectric element,
the base portion is connected to a body of the diaphragm, and
a width of the base portion is larger than a width of the top portion in a second direction that is at least one direction perpendicular to the first direction.

2. The inkjet device according to claim 1, wherein the pressure receiving portion includes at least a first portion having a width that gradually increases from the width of the top portion and reaches the width of the base portion.

3. The inkjet device according to claim 2, wherein the pressure receiving portion further includes a second portion having a width same as the width of the top portion between the first portion and the piezoelectric element.

4. The inkjet device according to claim 2, wherein the width of the first portion of the pressure receiving portion linearly increases.

5. The inkjet device according to claim 2, wherein the width of the first portion of the pressure receiving portion increases in a curved manner.

6. The inkjet device according to claim 1, wherein the pressure receiving portion includes a first protective film on a first surface facing the piezoelectric element.

7. The inkjet device according to claim 6, wherein the diaphragm has a second protective film on a second surface facing the pressure chamber.

8. The inkjet device according to claim 1,
wherein the piezoelectric element has a central region in the second direction and an end portion region adjacent to the central region in the second direction,
the central region receives a voltage applied to the piezoelectric element, and
the end portion region does not receive voltages applied to the piezoelectric element.

9. The inkjet device according to claim 8, wherein one of a first wiring and a second wiring is provided in the end portion region, and both the first wiring and the second wiring are provided in the central region, the first wiring being connected to a first electrode, the second wiring being connected to a second electrode which has a polarity different from a polarity of the first electrode.

10. The inkjet device according to claim 8, wherein the piezoelectric element has a chamfered portion at a corner portion of the end portion region on the diaphragm side.

11. The inkjet device according to claim 1, wherein a width of the top portion is smaller than the width of the piezoelectric element in the second direction.

12. An inkjet device comprising:
a pressure chamber that stores ink;
a piezoelectric element that is away from the pressure chamber in a first direction; and
a diaphragm that is disposed between the pressure chamber and the piezoelectric element in the first direction,
wherein the piezoelectric element has a central region in a second direction that is at least one direction perpendicular to the first direction, and an end portion region adjacent to the central region in the second direction,
the central region receives a voltage applied to the piezoelectric element, and
the end portion region does not receive a voltage applied to the piezoelectric element.

13. The inkjet device according to claim 12,
wherein the piezoelectric element further includes the central region adjacent to the end portion region, and
one of a first wiring and a second wiring is provided in the end portion region, and both the first wiring and the second wiring are provided in the central region, the first wiring being connected to a first electrode, the second wiring being connected to a second electrode which has a polarity different from a polarity of the first electrode.

14. The inkjet device according to claim 12, wherein the piezoelectric element has a chamfered portion at a corner portion of the end portion region on the diaphragm side.

15. An inkjet device comprising:
a pressure chamber that stores ink;
a piezoelectric element that is away from the pressure chamber in a first direction; and
a diaphragm that is disposed between the pressure chamber and the piezoelectric element in the first direction,
wherein the diaphragm includes a pressure receiving portion having a top portion which is in contact with the piezoelectric element, and
a width of the top portion is smaller than a width of the piezoelectric element in a second direction that is at least one direction perpendicular to the first direction.
